(19) United States
(12) Patent Application Publication
(10) Pub. No.: US 2023/0314125 A1
(43) Pub. Date: Oct. 5, 2023

(54) LINE-SCANNING CHROMATIC CONFOCAL SENSOR

(71) Applicant: HEBERSON TECHNOLOGY (SHENZHEN) CO., LTD, Shenzhen (CN)

(72) Inventors: Qiancheng WANG, Shenzhen (CN); GuoAn WANG, Shenzhen (CN); Kai HUANG, Shenzhen (CN); Guodong XIE, Shenzhen (CN); Fei ZHOU, Shenzhen (CN)

(21) Appl. No.: 18/313,505

(22) Filed: May 8, 2023

Related U.S. Application Data
(63) Continuation of application No. PCT/CN2021/072982, filed on Jan. 21, 2021.

(30) Foreign Application Priority Data
Nov. 16, 2020 (CN) 202022649161.7

(51) Int. Cl. G01B 11/06; G01B 11/02

(52) U.S. Cl. CPC G01B 11/0608; G01B 11/024; G01B 2210/50

(57) ABSTRACT

A line-scanning chromatic confocal sensor, including a line light source, a dispersion assembly, a receiving assembly, a slit and a processing assembly. The line light source is configured to output a continuous, uniform and broad-spectrum linear light beam. The dispersion assembly includes a first collimating element, a first dispersing element and a first focusing element. The receiving assembly includes a second focusing element, a second dispersing element and a second collimating element, and is arranged symmetrically with the dispersion assembly. The slit is configured to filter out component with a non-focusing wavelength from the reflected light. The processing assembly includes a third collimating element, a third dispersing element, a third focusing element and an image sensor.

### CROSS-REFERENCE TO RELATED APPLICATIONS

This application is a continuation of International Patent Application No. PCT/CN2021/072982, filed on Jan. 21, 2021, which claims the benefit of priority from Chinese Patent Application No. 202022649161.7, filed on Nov. 16, 2020. The content of the aforementioned application, including any intervening amendments thereto, is incorporated herein by reference in its entirety.

### TECHNICAL FIELD

This application relates to chromatic confocal measurement devices, and more particularly to a line-scanning chromatic confocal sensor.

### BACKGROUND

Chromatic confocal technology is a measurement method derived from confocal microscopy, in which different wavelengths of light sources are focused on different heights to achieve a height-wavelength correspondence, so as to realize the height measurement by detecting the confocal wavelength. Due to the characteristics of high precision, high speed and excellent stability, the chromatic confocal technology has been often employed in the industrial inspection, especially for the measurement of transparent objects.

Currently, most of the conventional chromatic confocal technologies adopt single-point measurement, where it is needed to move the object to be measured or the chromatic confocal sensor probe to complete the measurement for the height information of a line or plane, which will not only affect the measurement efficiency, but also reduce the measurement stability and precision due to the measurement errors brought by frequent movement.

### SUMMARY

An objective of this application is to provide a line-scanning chromatic confocal sensor, which realizes the rapid, precise, simple and stable height measurement of a line in one shot, so as to remedy the defects mentioned above in the existing technologies.

Technical solutions of this application are described as follows.

This application provides a line-scanning chromatic confocal sensor, comprising:
a line light source;
a dispersion assembly;
a receiving assembly;
a slit; and
a processing assembly;
wherein the line light source is configured to output a continuous, uniform and broad-spectrum linear light beam;
the dispersion assembly comprises a first collimating element, a first dispersing element and a first focusing element connected in sequence; the dispersion assembly is configured to disperse the linear light beam output from the line light source to form lights with different wavelengths, and focus the lights with different wavelengths respectively on different heights;
the receiving assembly and the dispersion assembly are symmetrically arranged; the receiving assembly comprises a second focusing element, a second dispersing element and a second collimating element connected in sequence; the receiving assembly is configured to receive a reflected light from a surface of an object to be measured and focus the reflected light to different positions;
the slit is arranged between the receiving assembly and the processing assembly; and the slit is configured to filter out a component with a non-focusing wavelength from the reflected light; and
the processing assembly comprises a third collimating element, a third dispersing element, a third focusing element and an image sensor connected in sequence; and the processing assembly is configured to receive and focus light passing through the slit on different positions on the image sensor to form a plurality of light spots.

In an embodiment, the line-scanning chromatic confocal sensor further comprises a processor; wherein the processor is configured to determine a position of a mass center of each of the plurality of light spots on the image sensor to calculate a height on the surface of the object to be measured.

In an embodiment, the processing assembly further comprises a first reflecting mirror and a second reflecting mirror; the first reflecting mirror is arranged between the slit and the third collimating element; the first reflecting mirror is configured to deflect the light passing through the slit to the third collimating element; the second reflecting mirror is arranged between the third collimating element and the third dispersing element; the second reflecting mirror is configured to deflect transmitted light of the third collimating element to the third dispersing element.

In an embodiment, the first reflecting mirror is inclined at an angle of 45° with respect to the slit, and is arranged along a length direction of the slit.

In an embodiment, the line light source is composed of a plurality of white light-emitting diodes (LEDs); and the plurality of white LEDs are linearly arranged.

In an embodiment, a diaphragm is provided in front of the line light source, and is configured to control a divergence angle of the line light source.

In an embodiment, the slit comprises two black plates; the slit and the line light source are the same in length; and a width of the slit is adjustable.

In an embodiment, the first collimating element, the second collimating element, and the third collimating element each comprise at least one collimating lens.

In an embodiment, the first dispersing element, the second dispersing element, and the third dispersing are independently a prism, a grating, or a combination thereof.

In an embodiment, the first focusing element, the second focusing element, and the third focusing element each comprise at least one focusing lens.

Compared with the prior art, this application has the following beneficial effects.

The sensor provided herein employs a line light source for illumination, which realizes the line confocal wavelength measurement, and one-shot measurement of the height information of a line. Compared to the traditional single-point chromatic confocal sensors, this application has significantly improved measurement efficiency, precision and stability, and simplified operation. In addition, by introducing a reflector to the processing assembly, the sensor becomes more structurally compact, effectively reducing the sensor size while ensuring the same measurement performance.

### BRIEF DESCRIPTION OF THE DRAWINGS

FIG. 1 structurally shows a line-scanning chromatic confocal sensor according to Embodiment 1 of this application;

FIG. 2 structurally illustrates a dispersion assembly according to Embodiment 1 of this application;

FIG. 3 structurally illustrates a receiving assembly according to Embodiment 1 of this application; and

FIG. 4 structurally illustrates a processing assembly according to Embodiment 1 of this application.

In the drawings, 1, line light source; 2, dispersion assembly; 21, first collimating element; 22, first dispersing element; 23, first focusing element; 3, receiving assembly; 31, second focusing element, 32, second dispersing element; 33, second collimating element; 4, slit; 5, processing assembly; 51, first reflecting mirror; 52, third collimating element; 53, second reflecting mirror; 54, third dispersing element; 55, third focusing element; and 56, image sensor.

### DETAILED DESCRIPTION OF EMBODIMENTS

This application will be described in detail below with reference to the accompanying drawings and following embodiments.

### Embodiment 1

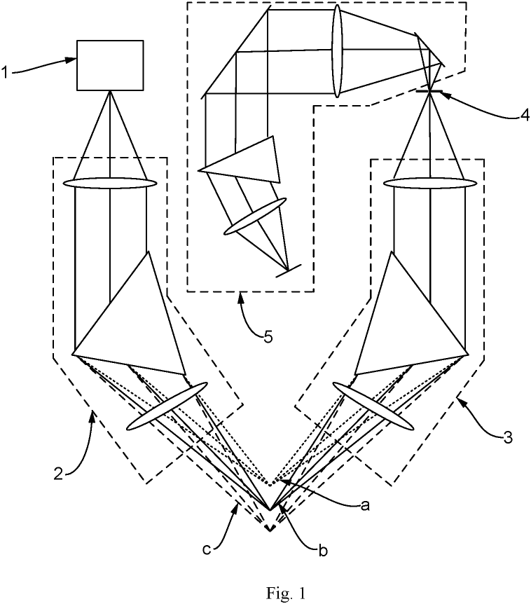

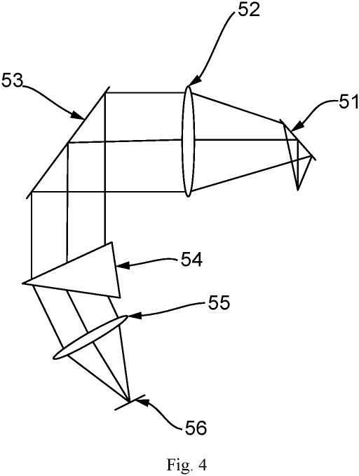

Referring to FIGS. 1 to 4, a line-scanning chromatic confocal sensor is provided, which includes a line light source 1, a dispersion assembly 2, a receiving assembly 3, a slit 4, a processing assembly 5 and a processor.

The line light source 1 is configured to output a continuous, uniform and broad-spectrum linear light beam. The line light source is composed of a plurality of white light-emitting diodes (LEDs), which are closely and linearly arranged, and have a continuous and uniform spectral distribution within a wavelength range of 400-700 nm. The white LEDs each have a strong light-emitting power to ensure the sampling speed of the sensor. The spectrum of each LED is continuous and uniform in the visible-light range. A diaphragm (not shown in the drawings) is provided in front of the line light source 1 to control the divergence angle of the line light source 1. In FIGS. 1-3, a is a light path corresponding to a wavelength of 400 nm; b is a light path corresponding to a wavelength of 500 nm, and c is a light path corresponding to a wavelength of 700 nm.

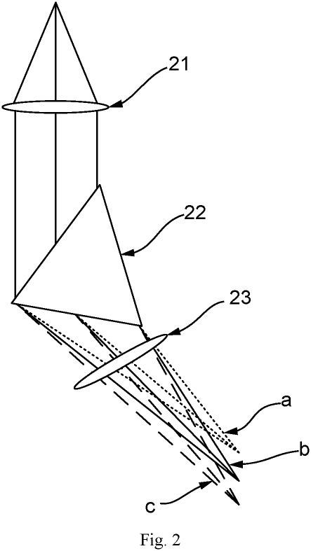

The dispersion assembly 2 includes a first collimating element 21, a first dispersing element 22 and a first focusing element 23 connected in sequence. The dispersion assembly 2 is configured to disperse the linear light beam output from the line light source 1 to form lights with different wavelengths, and focus the lights with different wavelengths respectively on different heights. The first collimating element 21 employs a collimating lens, and is configured to collimate the line light beam output from the line light source 1 into collimated light. The first dispersing element 22 employs a prism, and is configured to disperse the collimated light to form light with different wavelengths. The light beams with different wavelengths vary in emergent angle. The first focusing element 23 is a focusing lens for focusing the light with different wavelengths from the first dispersing element 22 respectively on different heights on the surface of the object to be measured to form a dispersion plane. The dispersion plane is perpendicular to the surface of the object to be measured, such that the correspondence between height information of wavelength information of a point on a line is realized. In FIG. 2, the light of 400 nm, the light of 500 nm and the light of 700 nm are respectively focused on different heights. The dispersion plane formed by all points on the line is perpendicular to the surface of the object to be measured.

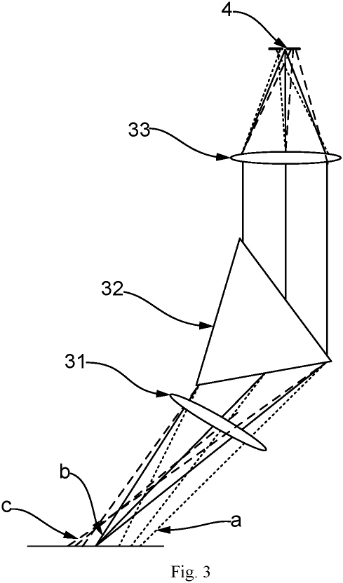

The receiving assembly 3 and the dispersion assembly 2 are symmetrically arranged. The receiving assembly 3 includes a second focusing element 31, a second dispersing element 32 and a second collimating element 33 connected in sequence. The receiving assembly 3 is configured to receive a reflected light from a surface of an object to be measured and focus the reflected light to different positions. The second focusing element 31 employs a focusing lens, the second dispersing element 32 employs a prism, and the second collimating element 33 employs a collimating lens. The light reflected from the surface of the object to be measured is received by the receiving assembly 3. After passing through the receiving assembly 3, the component with the focusing wavelength in the reflected light is received by the receiving assembly 3, and then focused on the slit 4. The component with the non-focusing wavelength in the reflected light is blocked by the slit 4, and fails to enter the processing assembly 5. In FIG. 3, the light with a wavelength of 500 nm is focused on the surface of the object to be measured, and the light with a wavelength of 400 nm and the light with a wavelength of 700 nm are defocused on the surface of the object to be measured. After the reflected light from the surface of the object to be measured passing through the receiving assembly 3, only the light with a wavelength of 500 nm is focused on the slit 4, and fails to enter the processing assembly 5 through the slit 4. The light with the wavelength of 400 nm and light with the wavelength of 700 nm are blocked by the slit 4, and unable to enter the processing assembly 5.

The slit 4 and the receiving assembly 3 are arranged in parallel with the line light source 1. The receiving assembly 3 focuses the reflected light from the surface of the object to be measured on different positions of a bottom surface of the slit 4. The slit 4 filters out a component with a non-focusing wavelength from the reflected light, and allows only the reflected light that is focused on the object to be measured to pass through. The slit 4 includes two black-coated metal plates. The length of the slit 4 is the same as the length of the line light source 1. The width of the slit 4 is adjustable. The width of the slit 4 is related to the sensor resolution and sampling speed, and is determined according to the actual situation. The narrower the width of the slit 4, the narrower the wavelength range of the light that enters the processing assembly 5. Consequently, the resolution of the line-scanning chromatic confocal sensor is higher. Moreover, the narrower the width of the slit 4, the weaker the system energy, such that measurement speed of the line-scanning chromatic confocal sensor will be reduced. In this embodiment, the width of the slit 4 may be 20-200 µm.

The processing assembly 5 includes a first reflecting mirror 51, a third collimating element 52, a second reflecting mirror 53, a third dispersing element 54, a third focusing element 55 and an image sensor 56 connected in sequence. The processing assembly 5 is configured to receive and focus the light with different wavelengths passing through the slit on different positions on the image sensor 56. The third collimating element 52 employs a collimating lens, the third dispersing element 54 employs a prism, and the third focusing element 55 employs a focusing lens. The first reflecting mirror 51 is arranged between the slit 4 and the third collimating element 52. The first reflecting mirror 51 is inclined at an angle of 45° with respect to the slit 4, and is arranged along a length direction of the slit 4. The first reflecting mirror 51 is configured to deflect the light passing through the slit 4 to the third collimating element 52. The second reflecting mirror 53 is arranged between the third collimating element 52 and the third dispersing element 54. The second reflecting mirror 53 is inclined at an angle of 45° with respect to the third collimating element 52. The second reflecting mirror 53 is configured to deflect the transmitted light of the third collimator 52 to the third dispersing element 54. The light passing through the slit 4 is reflected by the first reflecting mirror 51 and enters the third collimating element 52. The light is collimated by the third collimating element 52 and reflected by the second reflecting mirror 53, and then enters the third dispersing element 54. The third dispersing element 54 is configured to disperse the light to form light with different wavelengths, and allow the light with different wavelengths to enter the third focusing element 55 at different angles. The third focusing element 55 is configured to focus the light with different wavelengths on the image sensor 56 at different positions. The inclination angle of the second reflecting mirror 53 is not limited to 45°, and is adjustable according to actual requirements.

The processor is configured to determine a position of a mass center on the image sensor 56 to determine wavelength information of the light focused on the surface of the object to be measured, so as to calculate height information of the surface of the object to be measured based on the wavelength information and calibration information of height of the object to be measured. The algorithm used by the processor to detect of the position of a mass center on the image sensor 56 to calculate the height information of the surface of the object to be measured is disclosed in the prior art. In this embodiment, the processor is (but not limited to) an Advanced RISC Machine (ARM) Processor (Acorn Computers Ltd.). Moreover, the processor can be any microprocessor in the prior art without affecting the implementation of this application.

### Embodiment 2

Embodiment 2 is basically the same as Embodiment 1 except that the second reflecting mirror 53 is absent in this embodiment. The third dispersing element 54 is arranged to receive the parallel light path transmitted by the third collimating element 52. The third focusing element 55 is arranged to receive the light path transmitted by the third dispersing element 54. The image sensor 56 is arranged to receive the light path transmitted by the third focusing element 55.

### Embodiment 3

Embodiment 3 is basically the same as Embodiment 1 except that the first dispersing element 22, the second dispersing element 32 and the third dispersing element 54 each adopt a grating.

The embodiments described above are merely illustrative of this application, and are not intended to limit this application. It should be understood that various modifications made by those skilled in the art without departing from the spirit of this application should still fall within the scope of the present application defined by the appended claims.

What is claimed is:

1. A line-scanning chromatic confocal sensor, comprising:
a line light source;
a dispersion assembly;
a receiving assembly;
a slit; and
a processing assembly;
wherein the line light source is configured to output a continuous, uniform and broad-spectrum linear light beam;
the dispersion assembly comprises a first collimating element, a first dispersing element and a first focusing element connected in sequence; the dispersion assembly is configured to disperse the linear light beam output from the line light source to form lights with different wavelengths, and focus the lights with different wavelengths respectively on different heights;
the receiving assembly and the dispersion assembly are symmetrically arranged; the receiving assembly comprises a second focusing element, a second dispersing element and a second collimating element connected in sequence; the receiving assembly is configured to receive a reflected light from a surface of an object to be measured and focus the reflected light to different positions on an image sensor;
the slit is arranged between the receiving assembly and the processing assembly; and the slit is configured to filter out a component with a non-focusing wavelength from the reflected light; and
the processing assembly comprises a third collimating element, a third dispersing element, a third focusing element and the image sensor connected in sequence; and the processing assembly is configured to receive and focus light passing through the slit on different positions on the image sensor to form a plurality of light spots.

2. The line-scanning chromatic confocal sensor of claim 1, further comprising:
a processor;
wherein the processor is configured to determine a position of a mass center of each of the plurality of light spots on the image sensor to calculate a height on the surface of the object to be measured.

3. The line-scanning chromatic confocal sensor of claim 1, wherein the processing assembly further comprises a first reflecting mirror and a second reflecting mirror; the first reflecting mirror is arranged between the slit and the third collimating element; the first reflecting mirror is configured to deflect the light passing through the slit to the third collimating element; the second reflecting mirror is arranged between the third collimating element and the third dispersing element; the second reflecting mirror is configured to deflect transmitted light of the third collimating element to the third dispersing element.

4. The line-scanning chromatic confocal sensor of claim 3, wherein the first reflecting mirror is inclined at an angle of 45° with respect to the slit, and is arranged along a length direction of the slit.

5. The line-scanning chromatic confocal sensor of claim 1, wherein the line light source is composed of a plurality of white light-emitting diodes (LEDs); and the plurality of white LEDs are linearly arranged.

6. The line-scanning chromatic confocal sensor of claim 1, wherein a diaphragm is provided in front of the line light source, and is configured to control a divergence angle of the line light source.

7. The line-scanning chromatic confocal sensor of claim 5, wherein a diaphragm is provided in front of the line light source, and is configured to control a divergence angle of the line light source.

8. The line-scanning chromatic confocal sensor of claim 1, wherein the slit comprises two black plates; the slit and the line light source are the same in length; and a width of the slit is adjustable.

9. The line-scanning chromatic confocal sensor of claim 1, wherein the first collimating element, the second collimating element, and the third collimating element each comprise at least one collimating lens.

10. The line-scanning chromatic confocal sensor of claim 1, wherein the first dispersing element, the second dispersing element, and the third dispersing are independently a prism, a grating, or a combination thereof.

11. The line-scanning chromatic confocal sensor of claim 1, wherein the first focusing element, the second focusing element, and the third focusing element each comprise at least one focusing lens.
